(19) United States
(12) Patent Application Publication
(10) Pub. No.: US 2007/0214497 A1
(43) Pub. Date: Sep. 13, 2007

(54) System and method for providing a hierarchical role-based access control

(75) Inventors: Michael A. Montgomery, Austin, TX (US); Yi Mao, Austin, TX (US)

Correspondence Address: THE JANSSON FIRM, 9501 N. CAPITAL OF TX HWY #202, AUSTIN, TX, 78759, US

(73) Assignee: AXALTO INC.

(21) Appl. No.: 11/373,365

(22) Filed: Mar. 10, 2006

(51) Int. Cl. H04L 9/32

(52) U.S. Cl. 726/4

(57) ABSTRACT

Role-based hierarchical access control system and method. A computer system having a data storage capacity and a central processing unit and at least one resource has an access control data structure defining role-based access control lists for the resource, wherein the access control list defines based on the role of a user the types of access that the user may have to the at least one resource. A hierarchy of roles having at least a first role and a second role wherein the second role inherits the permissions granted to the first role for the at least one resource. Access to the resource is determined by comparing roles defined to have access privileges to the resource and the permissions granted to such roles to the role of an entity seeking access to the resource.

### TECHNICAL FIELD

The present invention relates generally to access control for computer-based resources and more particularly to a role-based hierarchical approach for providing access control of computer-based resources.

### BACKGROUND OF THE INVENTION

Modern computer systems provide software platforms that can host many applications in various application domains for various groups of users. In such environments it is crucial to manage the access rights offered to an individual user or group of users to a particular resource. A typical example of an access control application is access restrictions that are placed on a particular data file. Access control is an issue for all computers that have resources that may be accessed by multiple entities.

This is also true for smart cards and network smart cards in particular. The user groups on a network smart card could be, to name a few, card administrators, card issuers, service providers of various applications and cardholders. The applications might be providing web identities, conducting online transactions, or participating in health care programs. Each user is permitted to run a certain set of applications. Each application needs to access some resources such as certain files on the card. From the security perspective, different users and different applications must be prohibited from accessing confidential information associated with other users and other applications. This calls for an access control mechanism to enforce the security.

In Unix-style file systems, the traditional way of controlling file access is based on three sets of three permissions. Three permissions control read, write and execute operations, respectively. Each set of permissions is for one of three categories of accessing entities: the owner, the group, and the world (i.e., anyone). Typically, the owner of a resource is the entity, e.g., the user, who created the resource. The permissions are usually implementing using nine permission bits.

The Unix-style permissions schema lacks flexibility in several aspects:
1. The number of categories associated with a given file or resource is fixed to be three (one user, one group, and world). A frequently encountered problem is that more than one group should logically have access rights to a resource.
2. It is impossible for a user to belong to more than one group in the access control list. This limitation can be a severe hindrance in expressing reasonable security policies, particularly when there are many situations where an individual will have multiple roles. Moreover, there are fixed number of permission types, namely, read/write/execute.
3. It is impossible to organize roles. For example, we may have various medical groups, including emergency personnel, doctors, nurses, etc., that each belong to groups that express what resources that group can access. But there may be resources that we want to make available to all medical groups, but no others. Ideally, we should be able to organize groups of groups, to express this kind of security policy.

There is a strong need to avoid these limitations.

The access control mechanism in the Windows operating systems of Microsoft Corporation, Redmond, Wash., and in Unix-style systems with extended ACLs removed the restriction of having only nine permission bits as in traditional Unix. However, Windows and extended ACLs have limitations in other aspects, particularly point 3 above. The access control of these systems is built on two conceptually different components: users and roles. Though users can now be assigned to multiple roles, all roles are treated on the same level. Suppose that ten roles are allowed to have network connectivity. Then the right of having network connectivity must be explicitly associated with each of these ten roles. This is tedious and non-intuitive.

Roles in the real world can often be organized into a hierarchy. Some roles have a higher rank than others. Roles with a higher rank could implicitly have all rights of roles with a lower rank. For example, managers should naturally have all rights that regular employees have. To specify rights of managers, only the rights that are unique to the manager role should be explicitly stated, and the rights of employees can be implied from the fact that the manager role is higher than the employee role. Role hierarchy avoids repeatedly assigning the same set of rights both to managers and regular employees. However, the role hierarchy typically encountered everyday life, cannot be expressed in Windows, Unix-style systems, PVCS (Polytronic Version Control System, from Merant) and other prior art software configuration management tools.

Furthermore, for resource-constrained systems such as smart cards, the flat access control architecture is not only clumsy, but also wastes precious memory space to hold redundant information of access rights for roles that could otherwise be inherited from a hierarchical structure.

Considering the access control in terms of controlling access to an object (i.e., a resource on a computer system), there are two kinds of requesters of access. One refers to human users, and the other refers to applications running on the system. Human users access resources on the system in an indirect way by invoking certain programs that is delegated to directly access the intended resources on the user's behalf. Neither the Unix operating system nor the Windows operating system controls applications to restrict their access of resources on a case-by-case basis. When a program is invoked, that program obtains its access rights from the user who invokes it. Some programs even run with root privilege in Unix if SUID bit is set in permissions. Consider a scenario where a user downloads a program from the Internet. If the user runs this program and it is a malicious one, then it could damage all data that the user has access to. The above discussed access control mechanism cannot prevent this from happening. The incapability of separating access rights of two kinds of users (human users and applications that they invoke) becomes a major security hole, because the human users often cannot assure the nature of the applications that they are about to invoke.

To address the problem of running applications under user rights, some smart cards (e.g., .NET Card) implements both credential-based access control for applications (i.e. executable codes) and authentication-based access control for users. They are two separated control mechanisms and there is not a good way to link them together.

Therefore, it would be desirable to have a system that provides an access control mechanism that differentiates the access rights given to particular users and the access rights given to particular programs, regardless of which user is invoking the program.

Even though the access control on the application level can be imposed in addition to the control on the user level, for example, in the manner that the .NET Card does, there is still a need for a more fine-grained approach to access control to provide access control on the functional level. Some applications need exclusive rights to files on a functional basis. For example, write access of a bank application can be further subdivided into the right to increase a value, or the right to decrease a value, or any other kind of function needed. A merchant might be able to decrement a value for a purchase, but not increase the bank balance. A bank teller might be permitted to conduct the ordinary deposit/withdraw operations, but his supervisor should be able to correct an error on an account. An additional access control on the application level does not cover the different access needs from the functional level.

Mike Benoit, James Russell, and Karsten Dambekalns have described a product called phpGACL (Benoit, Mike, et al., Generic Access Control Lists with PHP) that provides a set PHP functions to apply access control to arbitrary objects (web pages, databases, etc) by other arbitrary objects (users, remote hosts, etc.). phpGACL arranges users in groups and arranges the groups in a tree data structure. To overcome limitations of this arrangement, phpGACL allows groups to appear at multiple locations in the tree. That solution undesirably increases the complexity of an access control system and increases the risk of introducing ambiguous access control policies. While phpGACL provides for a mechanism of arranging access control groups hierarchically, there is still an unmet need for allowing access control queries to take advantage of such a structure.

From the foregoing it will be apparent that there is still a need for an improved method to provide flexible and powerful access control methods there by overcoming foresaid limitations in preexisting access control systems.

### SUMMARY OF THE INVENTION

In a preferred embodiment, the invention provides a system and method for hierarchical role-based access control, which provides a high level of flexibility, high level of efficiency, and other hitherto unavailable benefits in the realm of resource access control.

A system and method for operating an electronic device to provide access control according to the invention provides an access control data structure defining role-based access control lists for at least one resource, wherein the access control list defines, based on the role of an accessing entity, the types of access that the accessing entity may have to the at least one resource and a hierarchy of roles having at least a first role and a second role wherein the second role inherits the permissions granted to the first role for the at least one resource. The role may be selected from the set consisting of a user, a program, a group of users, a group of programs. Other roles are also possible.

The system and method further provides for a login mechanism by which a user can indicate at least one role according to which a user wishes to log in. The login mechanism may provide login security policies that are a function of the at least one role to which the user wishes to log in and which define a validation method that the user must satisfy in order to be logged in to the at least one role. The login requirements for a lower level role may require a simple login policy and a higher level role may require a rigorous login policy.

The system and method further provides, in one embodiment, that there is a role-to-permission association for each resource item under the protection of the access control mechanism provided by the invention. The role-to-permission association may include a plurality of role-to-permission associations for any one resource item. The role-to-permission associations may be inherited from other resource items under the control of the system, for example, a file may inherit the resource-to-permission associations from the directory to which the file belongs.

The system and method for access control may be used with resource numerous different types of resource items including, but not limited to, resource items selected from the set including a file, a database record, a database table, a hardware device, an application, a virtual port, a socket, a cryptoprocessor, and a timer.

The system and method for access control according to the invention, in one embodiment, includes a mechanism for comparing the role to which an entity is logged into to role-to-permission associations for a resource to which the entity seeks access. In one aspect, the invention provides for an optimizer operable to compute the descendant roles to a role to which a user has been validated so that such descendant roles may also be compared against the role-to-permission associations. In one aspect, a descendant role may descend from multiple ancestor roles.

In one embodiment of the invention, the role-to-permission association for a particular item may includes specification of any operation permissible on the item by a role. While there is no restriction on the operations for which privileges may be associated with a role, the operations may be selected from the set including set access control list, read, write, execute and from the set including write_increase, write_decrease, increment, decrement.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which an electronic device according to the invention may be deployed.

FIG. 2 is a schematic illustration of an exemplary architecture of the hardware of an electronic device that may be used for implementations of the invention.

FIG. 3 is a block diagram of an exemplary software architecture that one may find implemented on an electronic device according to the invention.

FIG. 4 is a schematic illustration of the operation of an access control module according to the invention.

FIG. 5 is a schematic illustration of an example acyclic directed lattice that may represent one particular hierarchy of roles, set forth in FIG. 4, where the nodes represent roles and arrows are for the “is higher than” relation.

FIG. 6 is a schematic illustration of an example acyclic directed lattice that may represent one particular hierarchy of roles, in particular, an extension to the acyclic directed lattice presented in FIG. 5.

FIG. 7 is a schematic illustration of a binary tree representation of the acyclic directed lattice presented in FIG. 6.

FIG. 8 is a flow-chart illustrating one algorithm for inserting dummy nodes and logical copy nodes into an acyclic graph that may be used to convert the acyclic graph representation of the hierarchy into a binary tree version.

FIGS. 9-12 and 14 are schematic illustration showing example file system hierarchies.

FIGS. 13 and 15 are schematic illustrations showing example access control data structures according to the invention.

FIG. 16 is a flow-chart illustrating the process by which the access check module introduced in FIG. 4 may operate to grant or deny access to an entity seeking access to a resource to perform a particular operation.

FIGS. 17-19 are schematic illustration of acyclic directed lattice representations of a hierarchy of roles going through a series of operations for the purposes of providing an example of the operation of the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As shown in the drawings for purposes of illustration, the invention is embodied in an electronic device, e.g., a network smart card, equipped with an hierarchical role-based access control system. The system and method for access control according to the invention provides a highly complex access control scenarios that closely model real-world access privileges while requiring no additional hardware resources and very limited additional processing and memory resources and is therefore suitable for use in resource-constrained devices, i.e., devices with limited memory, bandwidth, or processing power.

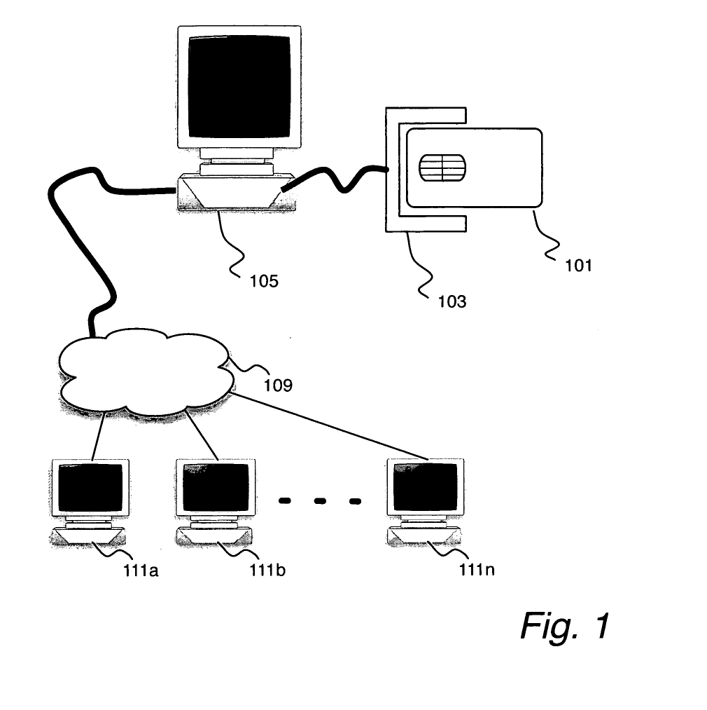

FIG. 1 is a schematic illustration of the operating environment in which an electronic device according to the invention may be deployed.

In one example, an electronic device 101 is a network smart card installed into a terminal 103. The terminal 103 may be a mobile telephone having the usual accoutrements of a mobile telephone such as a keypad, a display, a microphone and a speaker and the electronic device a SIM card. In alternative embodiments, the terminal 103 may be a personal digital assistant or any other mobile device using a SIM card. In yet another embodiment, the terminal 103 is a smart card reader connected to a host computer 105. The terminal 103 may contain an electronic circuitry (not shown) including a central processing unit and memory and provide input and output devices allowing interaction with the electronic device 101. Alternatively, interaction with the electronic device may be through user interface mechanisms on the host computer 105 or from other computers 111a-n connected to the electronic device via a network 109, either via the host computer 105 or directly to the electronic device. While in the example of FIG. 1, the electronic device is a resource constrained device that typically relies on the terminal 103 or other computers for input and output, the invention is not limited in applicability to such devices. Rather the invention may be used advantageously on many computerized electronic devices that have some access control requirements for objects stored thereon or functions available through the electronic device.

In one embodiment the electronic device 101 is a network smart card 101 which is a smart card that is capable to act as an autonomous Internet node. Network smart cards are described in co-pending patent application Ser. No. 10/848,738 “SECURE NETWORKING USING A RESOURCE-CONSTRAINED DEVICE”, reference.

The invention is also applicable for use in other devices, including other network-enabled resource-constrained devices, and is not necessarily limited in use to resource-constrained devices. For example, an electronic-device according to the invention may be a computer 111.

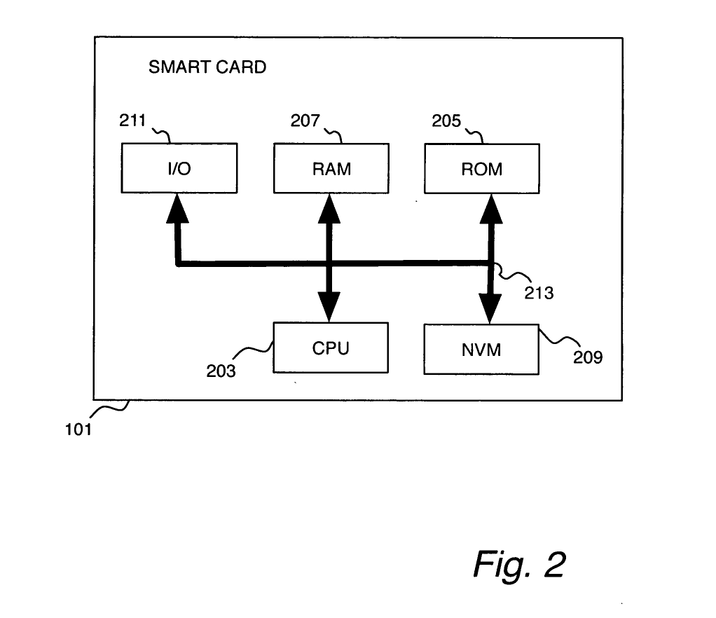

FIG. 2 is a schematic illustration of an exemplary architecture of the hardware of a electronic device 101 that may be used for implementations of the invention. The electronic device 101, according to the example of FIG. 2, has a central processing unit 203, a read-only memory (ROM) 205, a random access memory (RAM) 207, a non-volatile memory (NVM) 209, and a communications interface 211 for receiving input and placing output to a computer network, e.g., the Internet, to which the network-connected electronic device 101 is connected, either directly or via intermediary devices, such as a host computer 103′. These various components are connected to one another, for example, by bus 213. In one embodiment of the invention, an access control system module 311 (introduced herein below), as well as other software modules described herein below, would be stored on the resource-constrained device 101 in the ROM 205. In alternative embodiments, the software modules stored in ROM 205 would be stored in a flash memory or other types of non-volatile memory. For purposes of illustration, the invention is described using the ROM example. However, that should not be construed as a limitation on the scope of the invention and wherever ROM is used, flash memory and other types of non-volatile memory can be substituted as an alternative.

The ROM 205 would also contain some type of operating system, e.g., a Java Virtual Machine. Alternatively, the access control module 311 would be part of the operating system. During operation, the CPU 203 operates according to instructions in the various software modules stored in the ROM 205 or NVM 209.

Thus, according to the invention, the CPU 203 operates according to the instructions in the access control module 311 to perform the various operations of the access control module 311 described herein below.

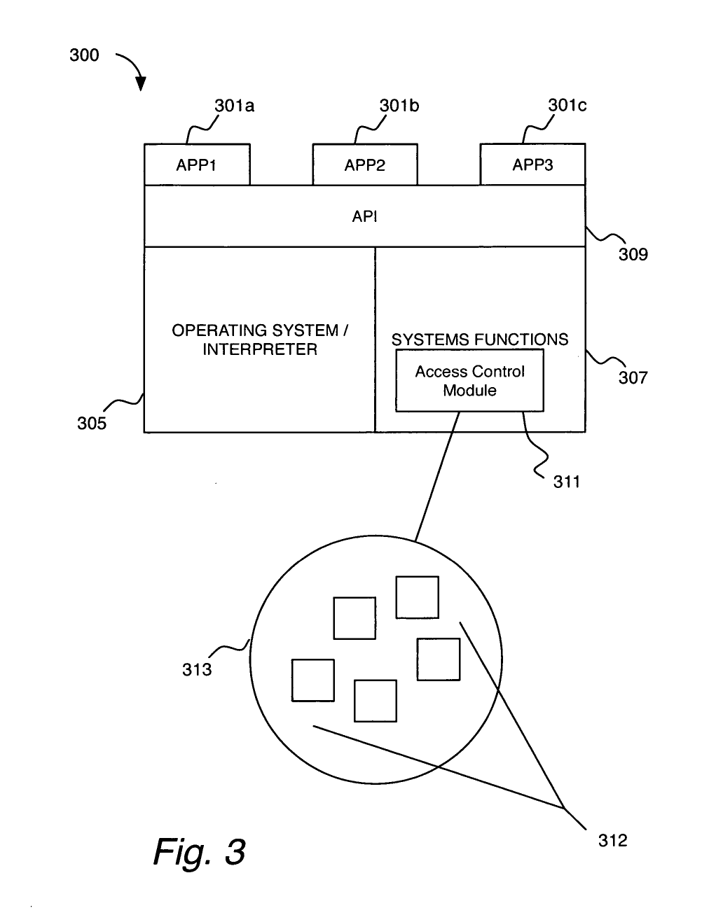

FIG. 3 is a block diagram of an exemplary software architecture 300 that one may find implemented on an electronic device 101. The software architecture 300 includes several application programs 301. The application programs 301 would typically be loaded into the non-volatile memory 209. However, in other scenarios an application program may be permanently written onto the smart card at manufacture by having it stored in the ROM 205. If the electronic device 101 is called upon to execute a program for only one session, it would be possible to have the program loaded in the RAM 207. However, that would be a rare circumstance. On the other hand, during execution of an application program, it is indeed possible that certain portions of the application program is loaded into the RAM 207.

In this example, several application programs 301 are executed by the CPU 203 under the control of instructions of an interpreter 305. The interpreter 305 may, for example, be a Javacard Virtual Machine as found on the Cyberflex smart card family from Axalto Inc. or the interpreter of a smart card implementing a .NET CLI (Common Language Infrastructure) as found in the .NET smart card technology from Axalto Inc. (www.axalto.com/infosec/NET_faq.asp). In alternative embodiments, the application programs 301 are compiled into executable code and do not require further interpretation by the interpreter 305. However, in such embodiments, the job control would be managed by some operating system program that would take the place of the interpreter 305.

The interpreter 305 is usually a static component of an electronic device 101 and would therefore be loaded into the ROM 205. The interpreter 305 may also be burned into some form of firmware. In another alternative the interpreter 305 may be stored in the non-volatile memory 209.

In most embodiments of the invention, the software architecture 300 also includes some system functions 307. System functions 307 may include security functionality, cryptography functionality, and utility libraries that may be called by application programs 301. The application programs 301 may access functions provided by the smart card system software 307 by issuing calls through an application program interface 309.

An example of the functions provided by the system functions 307 is access control, e.g., implemented as an access control module 311. The access control module 311 may be used to control access to resources 312 in a resource space 313. The resources may be databases, files, applications, utilities, hardware devices, etc.

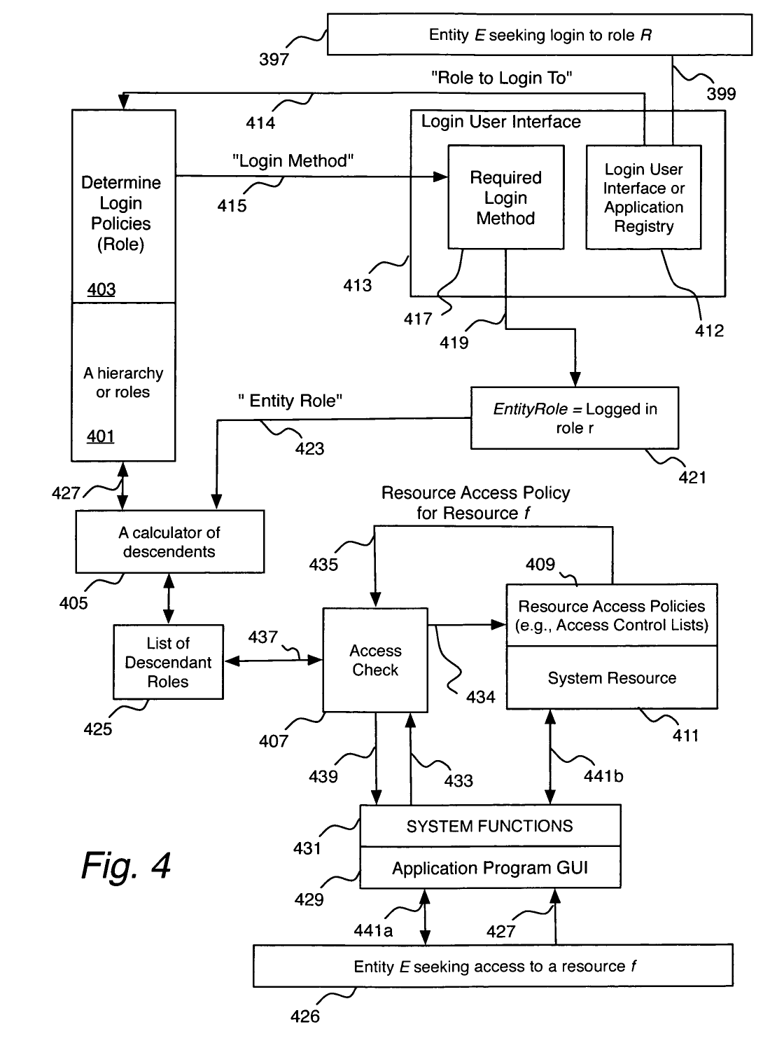

FIG. 4 is a schematic illustration of the operation of an access control module 311 according to the invention. FIG. 4 is a high-level view of the steps executed by the access control module to allow or deny a user access to resources on the electronic device 101.

An access control module 311 has two central components: a hierarchy of roles 401 and an access control policy associated with each system resource 409. According to one embodiment of the invention access control policies 411 are given by Access Control Lists that associate each system resource 411 with specified roles and the roles are organized into a hierarchical structure. Each user or application may be associated with one or more roles and have the access rights to a resource that is associated with that role. The roles are organized into a hierarchy, in a similar way as an organization chart may be hierarchically organized. Some roles have higher ranks than others. Roles with higher ranks dominate those with lower ranks and possess their rights as well.

Based on the hierarchical structure, different login policies 403 are associated to roles with different ranks. The role with the most privileges is linked to the most rigorous login mechanism, for example, presenting biometric information or a digital certificate. On the other hand, it may be sufficient for a low rank role to only present a password for very limited access to the system resources associated with that low ranking role. Moreover, one role may only be activated after a couple of other roles have jointly logged in. For example, some medical information can only be available when both a doctor and a patient have logged in, then a role of doctor_Patient can be created and place it in the hierarchy that it dominates both roles of doctor and patient. The login policy for role doctor_patient can be such that it is logged in when both roles of doctor and patient have logged in.

Besides the login policies 403, the access control module 311 contains a module for calculating descendants 405. The Calculator of Descendants 405 uses the hierarchy of roles 401 as its input. The hierarchy implies, for each role, all descendants of a given role. The descendants for a given role is used during access check 407, i.e., during the phase in which the access control module 311 is used to determine whether a particular user or application has access rights to a particular resource.

The second core component and its related components are the system resources 411 with an added layer of security defined by the resource access policies 409. For each item of system resources (e.g., each file in a file system), an access policy is defined to specify (1) who can access it; and (2) what can be done with it. Such a policy consists of a list of pairs whose first element defines who can access and whose second element defines the access rights associated with that first element. This category of components is resource-oriented.

The connecting point of role-oriented and resource-oriented components of the access control system of the present invention is the access check module 407. The access check module 407 compares, for each requested resource, roles contained in the access policy for that resource against the group of descendants of the role of the requesting entity. If two groups overlap, that signifies that the requesting entity has a role that has a rank at least as high as some permitted roles in the access policy and, accordingly, the requested access should be granted. Otherwise, the request of the access is denied.

An access check 407 is triggered by an access attempt on a resource by an entity. The access check 407 examines and determines whether a request of resource access from a user or an application that logs into the system using a particular role should be granted.

FIG. 4 is a data flow graph illustrating the operation of the access control module 311 according to the invention.

Step 1: an entity E 397 chooses a role to log into the system, step 399. This step could be executed by the user indicating a role to log into in a login window 412 using a user interface 413 or could be part of registering an application on the system (as discussed elsewhere herein, an entity can be, for example, a user or an application program). The “Role to Login To” is transmitted from the user interface 413 to a module for determining the corresponding login policies, step 414.

Step 2: The module for determining login policies 403 determines the login policies, and transmits the required “Login Method” back to the user interface 413, step 415, where the login requirements are displayed to the user on a login window 417.

Step 3: If the entity (i.e., a user, application or other requesting entity) satisfies the login requirements, the entity becomes logged into the system as having logged into a role r, step 419. For example, a variable EntityRole for the entity is set to a value indicative of the role to which the entity has logged into, step 421.

Step 4: Once an entity has been successfully logged into a role r, the system invokes the calculator of descendants 405 to determine the descendant roles 425 of the EntityRole, step 423. To perform that action, the calculator or descendents accesses the hierarchy of roles 401 to find the roles that are lower than the EntityRole in the hierarchy.

Step 5: The roles determined to be lower than the EntityRole is stored in a List of Descendant Roles 425 to be available for any resource access attempts by the entity.

Step 6: The Entity E 426 seeks access to a resource f for an operation o, step 427. This access may be through an application program graphics user interface 429 and some system functions 431. One of the system functions 431 may be to perform an access check prior to allowing access to the resource for a given operation.

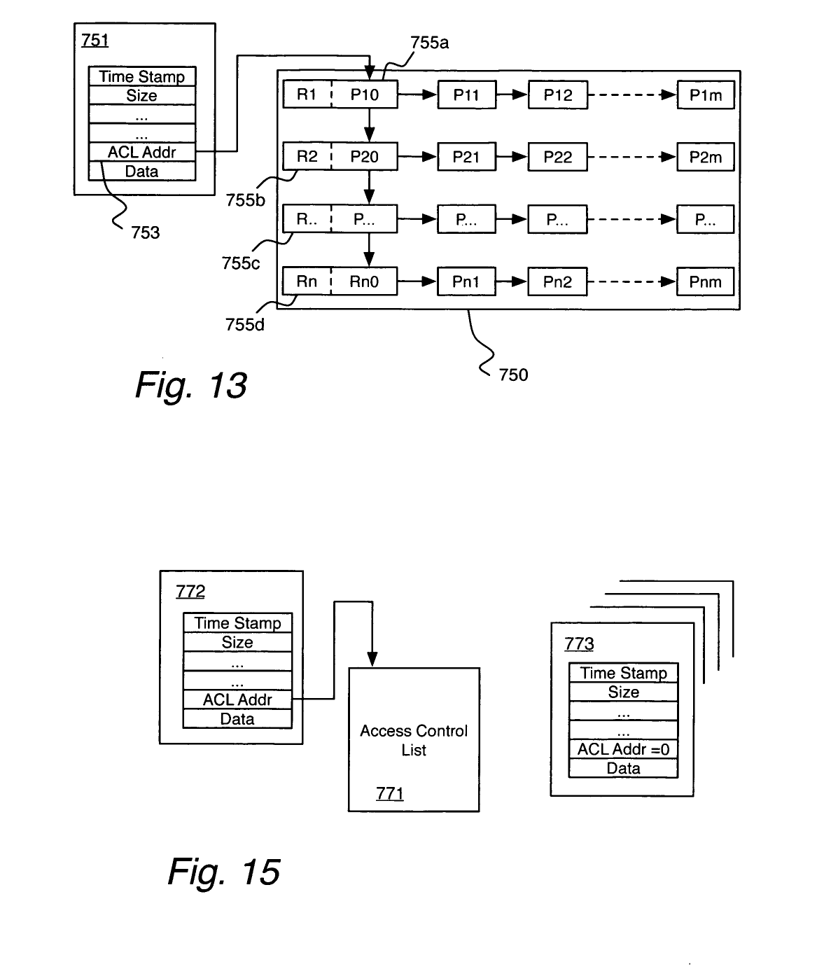

Step 7: The system functions 431 invokes the access check module 407, step 433, and the access check module 407 queries the access control policy for the resource f, i.e., the access control list 409 for resource f, to determine whether the EntityRole or any of its descendants have privileges to perform the operation o on the resource f, step 434. The access control list structure of the present invention is described in greater detail herein below in conjunction with the discussion of FIGS. 13-15. The Resource Access Policy is transmitted to the Access Check module 407, Step 435.

Step 8: The access check module 407 queries (or retrieves) the list of descendent roles 425, step 437.

Step 9: If the set of descendent roles 425 intersect with the roles having permission to execute operation o of the resource r, the access check module 407, grants the requested permission by providing appropriate indication to the system functions that provide the access, step 439, and the Entity E may now access the resource f, step 441a and 441b, typically through calls on some system functions.

The components of the access control system of the present invention, e.g., the components illustrated and discussed in conjunction with FIG. 4, are described in greater detail below.

Hierarchy of Roles 401

The hierarchy of roles 401 is a central component of a preferred embodiment of the present invention. The hierarchy of roles 401 may be an acyclic directed graph, in the simplest case a tree-structured graph. In the preferred embodiment the hierarchy of roles 401 is an acyclic directed lattice that has a maximal element, which can also be considered the most powerful role, and a minimal element, which can be considered the least powerful role. However, the exemplary use of an acyclic directed lattice must not be construed as a limitation.

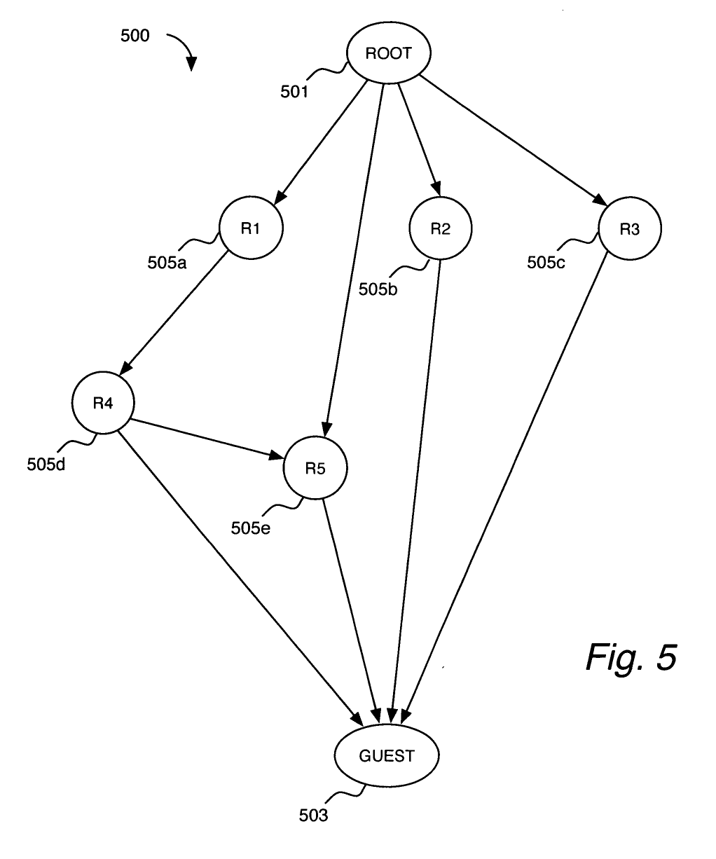

FIG. 5 is a schematic illustration of an example acyclic directed lattice 500 that may represent one particular hierarchy of roles 401 where the nodes represent roles and arrows are for the “is higher than” relation. The ROOT role 501 is the most powerful role and the GUEST role 503 is the most restricted role (i.e. the lowest role). All other roles 505a-e are located in the hierarchy somewhere in between the ROOT role 501 and the GUEST role 503. For example, role R5 505e is lower than ROOT 501, roles R1 505a and R4 505d, but higher than GUEST 503. Similarly, role R4 is lower than ROOT 501 and R1 505a, but higher than R5 505e and GUEST 503.

Hierarchy of Roles 401 Contrasted with Prior Art

The access control on Microsoft Windows is one of many existing systems that do not organize roles into a hierarchy. The benefits of having a hierarchical structure becomes clear when it is compared with systems such as Windows.

In Windows, defining a desired access policy for a user is performed in two steps. First, a user is assigned to some roles. Secondly, for each of roles, the tasks (i.e. applications) that role can perform is specified. Table 1 and Table 2 illustrate an example where U1 and U2 are two users, R1-R5 are five roles, and A1 and A2 are two applications. Table 1 shows the user-role assignments. Table 2 defines, for each role, what application(s) the role can execute. Table 1 and Table 2 jointly determines that U1 can run applications A1 and A2, and that U2 can only execute A2.

TABLE 1
user-role assignments

| User | Role |
|---|---|
| U1 | R1, R4, R5 |
| U2 | R2, R3, |

TABLE 2
role-application assignments

| Role | Application |
|---|---|
| R1 | A1, A2 |
| R2 | A2 |
| R3 | A2 |
| R4 | A1, A2 |
| R5 | A2 |

Users, roles and applications are three different types of entities in Windows. The same application (e.g., A2) has to be independently associated to every role, one by one. However, with a hierarchy of roles in place such as according to the present invention, users and applications can be uniformly treated as roles as well. With the roles positioned in appropriate places in the hierarchy, user-role assignments and role-application assignments can be avoided. The access controls on the applications do not have to be separated from that on users. Applications access system resources directly on the behalf of users. Users access resources indirectly by invoking some applications to carry out the tasks. Applications are also themselves resources for users. The notion of role bridges two ends and covers them all in one hierarchy.

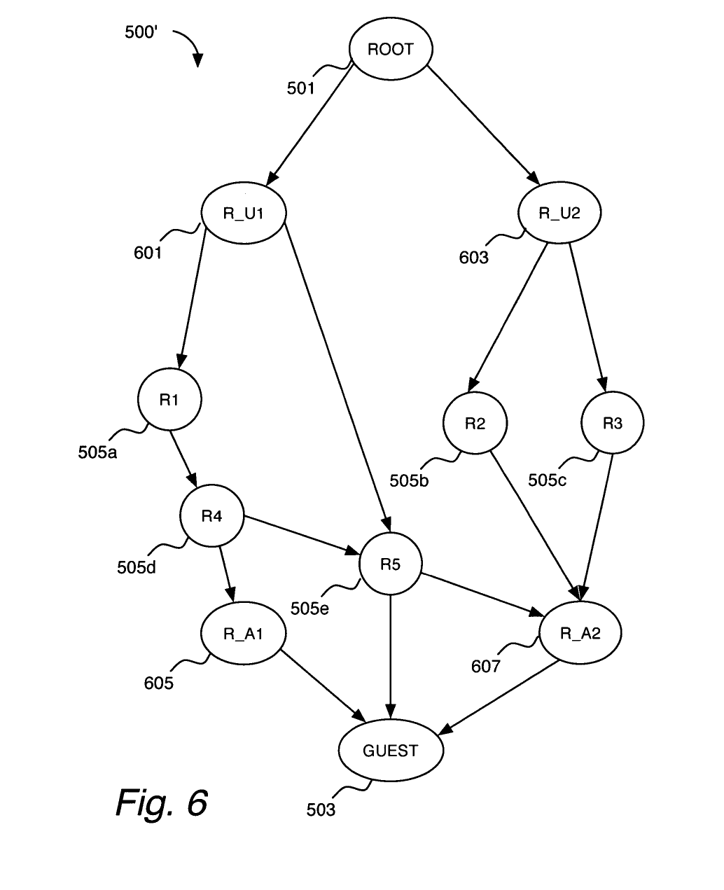

FIG. 6 is a schematic illustration of an example acyclic directed lattice 500′ that may represent one particular hierarchy of roles 401, in particular, an extension to the acyclic directed lattice 500 presented in FIG. 5. The acyclic directed lattice 500′ is obtained by creating two roles R_U1 601 and R_U2 603 for users and two roles R_A1 605 and R_A2 607 for applications, and inserting them into the existing hierarchy 500 as shown by FIG. 5. The hierarchy 500′ contains not only all the information provided in Table 1 and Table 2, but also the hierarchical relations among roles R1—R5 including R_U1, R_U2, R_A1, and R_A2. Whether user U1 has the right to execute application A1 is equivalent to whether there is a path starting at R_U1 601 and ending at R_A1 605. The hierarchical approach is conceptually less complex.

Hierarchy of Roles 401, Implementation

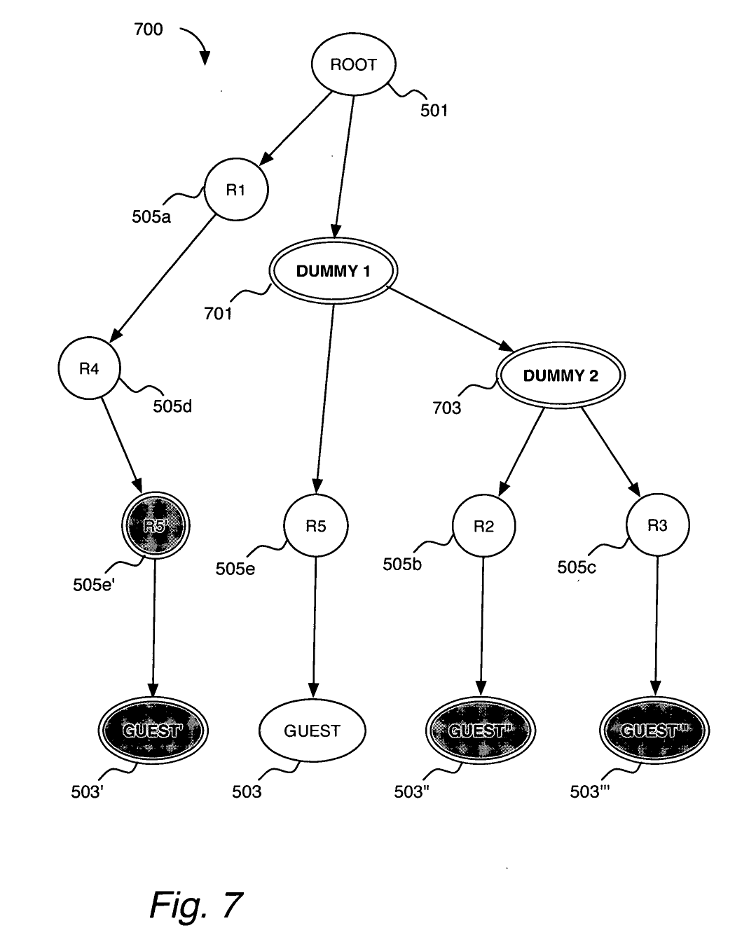

In one embodiment of the invention, a binary tree 700, as shown in FIG. 7, is used in the implementation to internally represent the role hierarchy 401. Binary trees are easy to create, to maintain, and to be searched for. The binary tree is one of the most well-studied data structures. Many optimization techniques that have been developed to deploy binary trees are quite mature. The choice of using a binary tree enables the possibility to deploy optimization techniques, which are important for implementations of the invention on resource-constrained devices like smart cards. The implementation of a binary tree structure for the hierarchy of roles is suited to the network smart card.

In order to turn a graph, such as the graph 500, into a binary tree, such as the binary tree 700, dummy nodes are added. When a node such as ROOT 501 has more than two children, e.g., R1 505a, R2 505b, and R3 505c, a dummy node (e.g., Dummy1, node 701) is inserted under ROOT 501 to hold two children R2 505b and R3 505c. The node Dummy1 701 is made a child of ROOT 501. By doing this, the number of children of ROOT 501 is decreased by 1 and its previous children R2 505b and R3 505c become its grandchildren. This process continues by introducing more dummy nodes (e.g., Dummy2 703) for any nodes that have more than 2 immediate descendants. Dummy nodes are not visible to the outside of the world. The users of the system are not aware of their existence.

A binary tree does not have any node that is a common child of several parents. In other words, multiple edges do not converge to the same node. To satisfy this requirement, logical copies for any such nodes are added to the binary tree 700 (e.g., gray nodes are used in FIG. 7 to represent logical copies of their originals). For example, being a child of node R4 505d and ROOT 501, node R5′ 505e′ is added as a logical copy of node R5 505e. Similarly, logical copies of node GUEST 503, nodes GUEST′ 503′, GUEST″ 503″ and GUEST′″ 503′″ are added as children of R5′ 505e′, R2 505b and R3 505c, respectively. In a preferred embodiment, no physical copies of nodes are made for converting a graph into a binary tree representation.

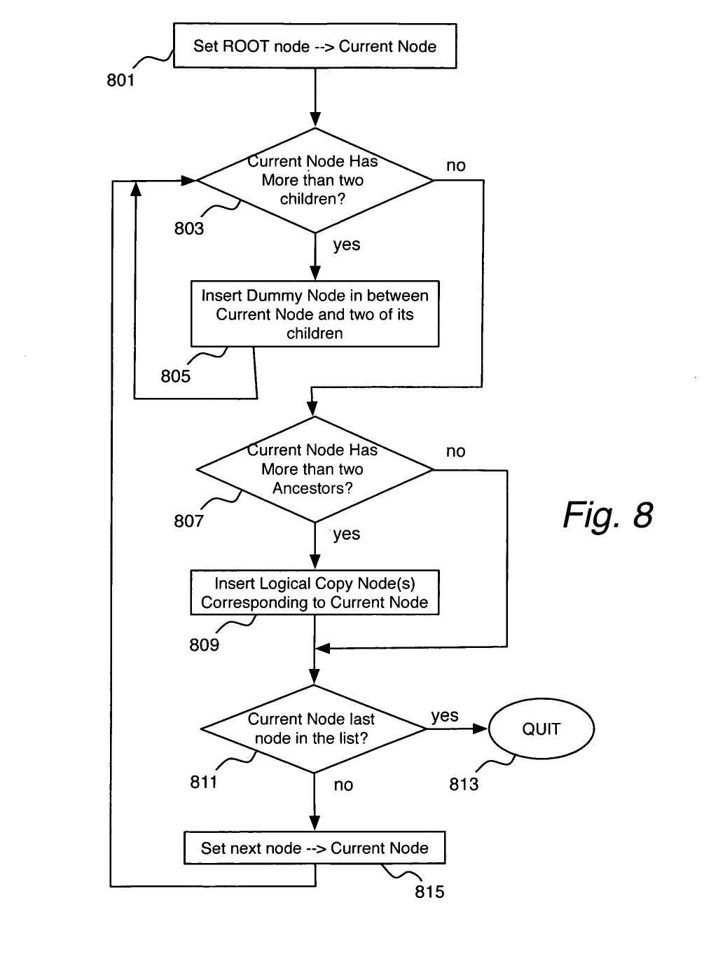

FIG. 8 is a flow-chart illustrating one algorithm for inserting dummy nodes and logical copy nodes into an acyclic graph that may be used to convert the acyclic representation of the hierarchy 401 into a binary tree version. The algorithm operates on a breadth-first order traversal of the nodes in the acyclic graph representation of the hierarchy 401. It maintains a variable CurrentNode that points to a particular node being operated on. First the CurrentNode is set to the ROOT node, step 801. Next, if the CurrentNode has more than two children, step 803, a Dummy node is inserted between the CurrentNode and two of its children, step 805. The process of adding Dummy nodes repeats until the CurrentNode has no more than two children. If the CurrentNode has more than two ancestors, step 807, a logical copy corresponding to the CurrentNode is inserted as a child for each ancestor except for one ancestor, step 811.

If the CurrentNode is the last node in the list of nodes, the algorithm terminates, step 813. Otherwise, the CurrentNode is set to the next node in the list, step 815, and the process repeats at step 803.

Application Program Interface

As illustrated in FIG. 3, an Application Program Interface (API) 309 provides application programs 301 access to system functions 307. The Access Control Mechanism 311 is one such system function. There is no particular required set of API functions. However, in an embodiment the API 309 implements API functions to maintain and update the hierarchy of roles 401. In one embodiment, the API functions 309 are shell functions. In that embodiment, the shell interface includes functions to display the hierarchy of roles (showrh( )), to add a role (addrole( )), the delete a role (delrole( )), to add a hierarchical relationship (addrh( )), and to delete a hierarchical relationship (delrh( )).

showrh( )

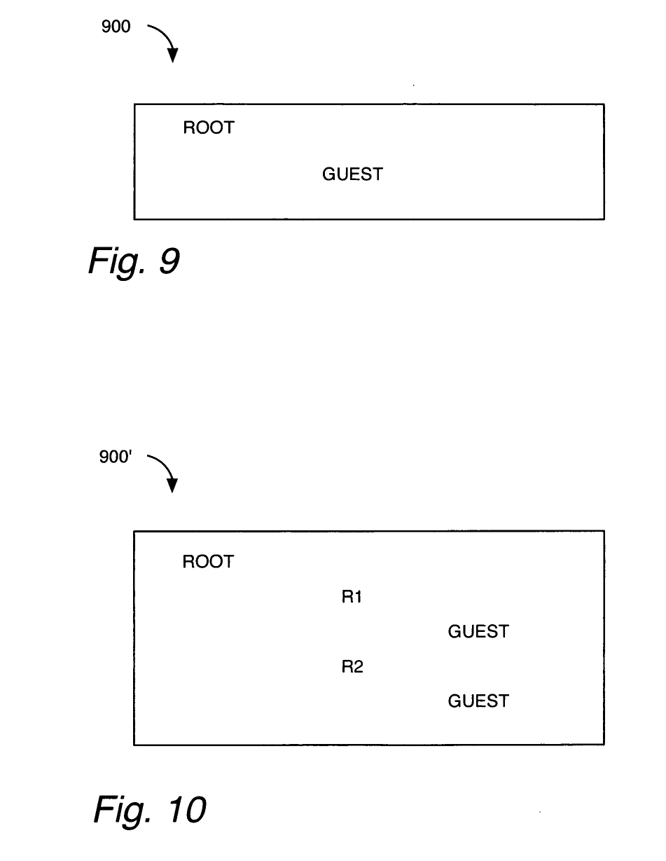

The function showrh( ) displays the binary tree representation of the current hierarchy of the roles. For example, the tree root is displayed at the left end, and leaf nodes are at the right end. The indention between two levels indicates the “higher than” relation. Initially, the hierarchy 401 would only contain two basic elements: ROOT and GUEST. Function showrh( ) displays the initial hierarchy 401 as illustrated in display 900 of FIG. 9.

addrole( )

The addrole( ) function adds a new role into the hierarchy, and places it in between ROOT and GUEST. FIG. 10 shows the resulting hierarchy 900′ after making function calls of addrole (R1) and addrole (R2) to the hierarchy 900.

delrh( ) and addrh( )

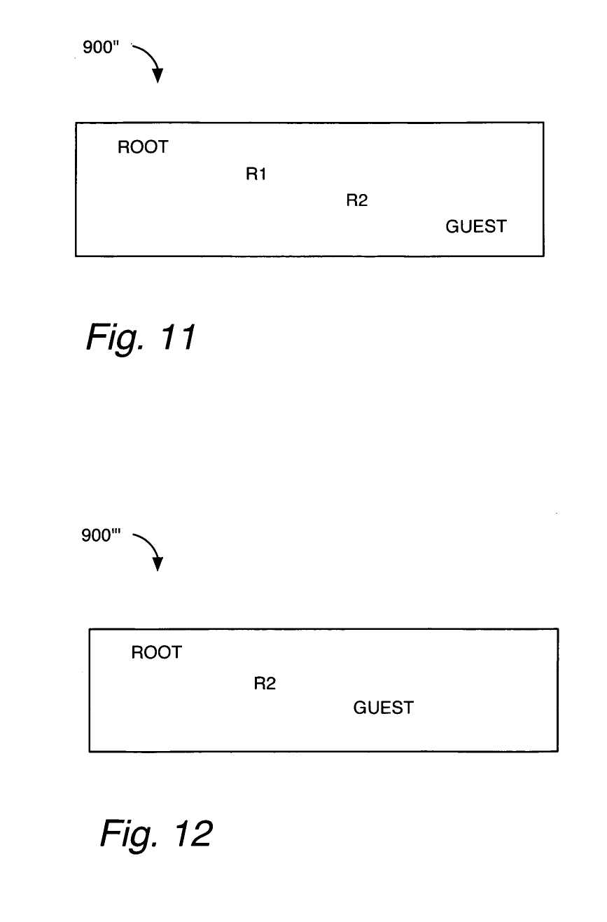

If the initial in-between position of R1 and R2 between ROOT and GUEST, e.g., as shown in hierarchy 900′, for a newly added role is not correct, the hierarchical relation can be adjusted by functions delrh( ) and addrh( ). delrh( ) deletes the “higher than” relation between two roles, and addrh( ) adds such a relation. A call of delrh(ROOT, R2) followed by addrh (R1, R2) turns hierarchy 900′ into 900″ of FIG. 11.

delrole( )

The delrole( )function deletes an existing role from the hierarchy of roles. Unlike the delrh( )function, delrole( )removes the specified role, but not a relation associating two roles. While delrh(ROOT, R1) deletes the link that bridges ROOT to the rest of nodes and only ROOT will be displayed in response to showrh( ), delrole(R1) only deletes the role R1 and all of its descendants will move up. Hierarchy 900′″ of FIG. 12 illustrates the resulting hierarchy after the call of delrole(R1).

As a person skilled in the art will appreciate, the five functions discussed above, though the names of functions may differ in different implementations, consist of an interface that is fully competent to create a hierarchy of roles and modify it to fit the expected shape. The interface does not have to be in the form of shell commands. For example, the same functionality can also be provided by a dedicated CGI via an underlying Web server.

From the implementation perspective, delrh( ) and addrh( ) are more fundamental than delrole( ) and addrole( ) in the sense that the latter makes use of the former. In the process of adding or deleting roles, the relations between the role and the rest of the hierarchy need to be added or deleted as well.

Access Control List 409

In a preferred embodiment of the invention, the access policies protecting the system resources 312 are contained in Access Control Lists 409 associated with each resource item 411.

A set of specific access control policies is implemented on the file system of the Network Smart Card. Network Smart Card has Unix like file system. Directories are treated as files. It is much more flexible and expandable than the file system on the conventional smart cards. In such a file system, for each file, there is an inode that holds all metadata about the file like the creation time of the file, the file size. The access control information is added in the inode structure of the file as another type of metadata.

FIG. 13 is a schematic illustration showing an exemplary the access control information 750 of a file. The inode 751 of file f has an additional field ACL 753 that holds the memory address of the first ACL record 755a. There could be as many ACL records 755 as desired to consist of an ACL 750 of file f. With the growth of ACL 750, if one data block is used up, more data blocks can be allocated and chained together with the previous block to hold more ACL records. The size of date block for ACL records is adjustable. As the space for an ACL is dynamically allocated, the length of an ACL does not have to be fixed. It could well vary from file to file solely depending on the access policies desired.

An ACL record 755 is a pair consisting of a role and a list of permissions, denoted as <role, p1p2 . . . pm>. The length of permissions and the types of permissions are flexible. Besides the traditional read/write/execute permissions, other permissions on new types of operations can be added. Table 3, below, is a list of possible permission values. For example, “S” listed in Table 3 is a new type of permission that is implemented to control which roles are allowed to set an ACL 750 for a file. It should be noted that these are merely examples and that any possible operation may be supported by an implementation of the invention. For example, in an application that manages financial accounts, the write permission can also subdivided into write_increase and write_decrease permissions. The fine-grained access control on the functional level (i.e. operational level) can be achieved by defining more permission types or subdividing existing ones to finer operations.

TABLE 3

| Permission Type | Description |
|---|---|
| S | set access control list |
| R | Read |
| W | Write |
| X | Execute |

The hierarchy of roles 401 that is discussed herein brings benefits in at least two aspects with respect to access control lists. One is that the ACL 750 of a file can be much shorter than otherwise required. The other is that access rights for a user or an application that the user executes can be differentiated and the access control on the application level can be achieved with ease.

Referring to the hierarchy 500′ given in FIG. 6 and, in particular, to the path ROOT→R_U1→R1→R4→R_A1, where the arrow “→” is the “higher than” relation. Suppose that a file f may be accessed by all of these roles with read permission. The ACL of file f is simply one pair (i.e., <R_A1, R>) which signifies that the role R_A1 has the read permission. The read permission for other roles higher than R_A1 can be inferred from the hierarchy. Without the role hierarchy, the ACL of file f would be much longer: <ROOT, r>, <R_U1, r>, <R1, r>, <R4, r>, <R_A1, r>.

In connection to viewing an application A1 as role R_A1 605 and placing the role R_{—A}1 605 lower in the hierarchy than the role R_U1 601 created for a user U1 who invokes the application A1, R_U1 601 can specify far fewer rights than R_{—A}1. For example, the ACL of a file f1 is <R_A1, r>, but ACL of another file f2 could be <R_U1, rwx>. In this setting, even if A1 is malicious software, the damage it may cause can be limited only to file f1, while file f2 will remain intact.

Inheritance of ACL

Logically, each resource 411 in a system protected by access control should be associated with an ACL 409. When an economic implementation is concerned, due to the hierarchical structure of a file system, a file may inherit the ACL of its ancestor, where an ancestor could be its parent directory or an ancestor of its parent. It is often happen that files in the same directory are expected to have the same ACL. In that case, it is sufficient to attach an ACL 409 to the directory and let all files under this directory inherit the same ACL.

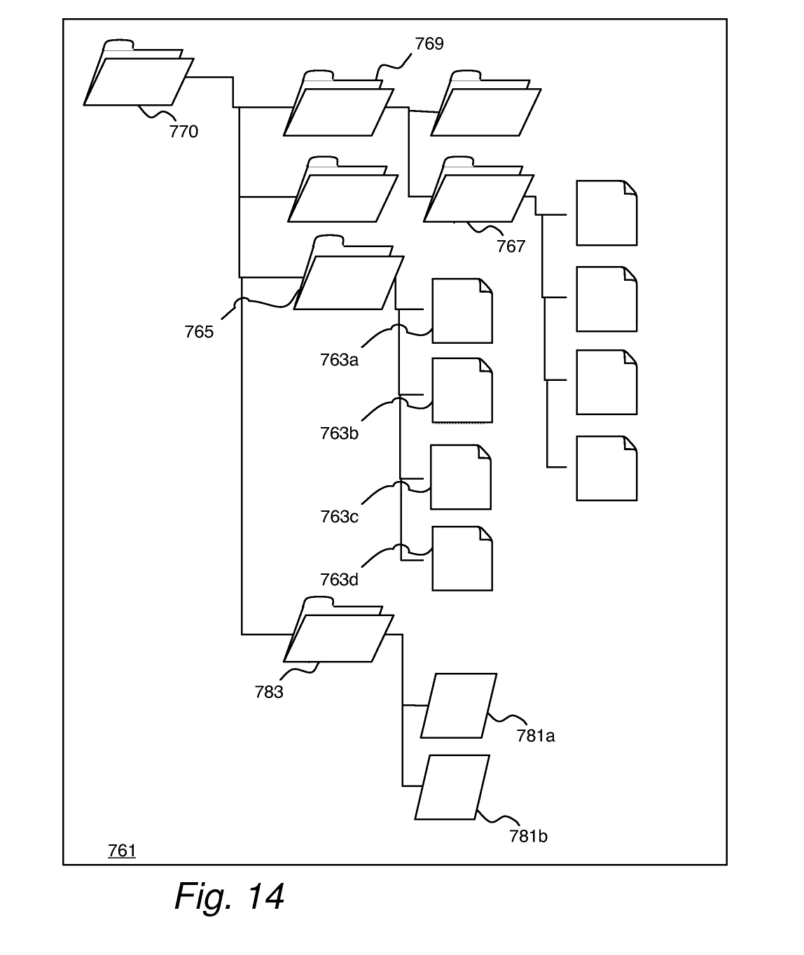

Consider, for example, the file system 761 illustrated in FIG. 14. In this scenario, the files 763a-d all belong to the same directory 765. It may be deemed that all files in directory 765 would have the same access control policy. Therefore, it would only be necessary to associate an access control list with the directory 765 and have that access control list inherited by the files 763a-d.

FIG. 15 is a schematic illustration of the access control structure corresponding to the directory 765 and its contained files. Instead of actually allocating space for each of directory 765 and files f1-f4 763a-d to hold ACL information, it is sufficient to only allocate space for an ACL 771 for directory 765 which is pointed to by inode 772. The “ACL Addr” fields of the inodes 773 of files f1-f4 763a-d are set to be 0. This means that their ACLs are not specifically set. ACLs of f1-f4 763a-d are not explicitly given, as these ACLs are inherited from the ACL 771 for directory 765. The ACLs of files f1-f4 can be obtained by asking the ACL of its parent directory 765. The process of querying about ACL information is recursive. In case that a given directory does not have an ACL explicitly set, that directory's ACL is determined from its parent's ACL and passes that ACL down onto the files it contains. For example, if neither directory 767 nor directory 769 have ACL associated explicitly therewith, the ACL of directory 770 would be inherited by the directories 767 and 769 as well as the files contained in directory 767.

The inheritance of ACLs avoids redundantly storing the same ACL multiple times for a group of files, and hence it dramatically saves the memory space. This technique is especially valuable for the resource-constrained devices such as smart cards.

API Functions for ACL Management

In an embodiment of the invention, as part of the initialization of the file system, each file is provided an ACL. Because of ACL inheritance, discussed herein above, providing initial ACLs is only necessary for a few directories. As an extreme case, only the root directory “/” is provided an initial ACL and the rest of files can simply inherit from this ACL. Similarly other resources, that are protected by ACLs, are initialized by providing initial ACLs. Assigning ACLs to other resources can also entail providing an initial ACL that is inherited. For example, in the directory structure 761 of FIG. 14, the applications 781a and 781b may not have been provided initial ACLs and therefore inherit an ACL from the directory 783 that contains those two applications.

The system functions 307 through the API 309 provides certain functions for managing the ACLs provided to resources 312.

Shell Command: ls-l

The ACL of a file or a directory can be viewed by typing a shell command “ls-l”, which means to list the file information in the long format. Table 4 shows an example of the use of the ls-l command and an example results that the system displays. “Jsmart %” is the shell prompt after a user Jsmart logged into the system. In response to the command “ls-l dir1”, the system displays the information of the directory dir1 and three files it contains. For each item (a directory or a file), the displayed information includes the type of the file (e.g., “d” for directory, and “-” for file), date and time on which it is created or modified, size of the file, and ACL of the file. Here the displayed ACLs are logical ACLs. It is not distinguishable, from the user point of view, whether the ACL of a file is part of its inode or is inherited from its parent directory. For instance, the ACL of f3 could well be inherited from dir1.

“ls-l” is a standard UNIX shell command, but its function in an implementation of the invention is enriched to display ACLs according to the invention rather than the nine permission bits.

TABLE 4
Jsmart% 1s - 1 dir1

| dir1 | d | 9/21/2005 | 4:01pm | 256 | guest | srwx |
|---|---|---|---|---|---|---|
| f1 | — | 9/25/2005 | 10:22am | 29 | Jsmart | srwx |
| | | | | | guest | -r-x |
| f2 | — | 9/25/2005 | 10:23am | 58 | guest | -r-x |
| f3 | — | 9/25/2005 | 5:10pm | 16 | guest | srwx |

Shell Command: chacl

This initial ACL can be changed by a shell command “chacl”. The syntax of this command is:

chacl path role=permission [options]

where the options are more equations of role=permission and each of them is separated by “,” to the next equation. This command changes the access control of the specified path for the specified role to be the specified permission. The path can be of a directory or of a file, and can be absolute or relative. If the path is not given, its default value is the current working directory. When an empty permission is assigned to a role, this role will be removed from the access control list of the given path. Permissions can be given in two forms: as a string, or as a number. For example, ‘srwx’ and ‘-r-x’ are permission strings. The correspondence between numbers and permissions are: ‘s’ is 8, ‘r’is 4,‘w’is 2 and ‘x’ is 1. For example, 15 means ‘srwx’ and 9 stands for ‘s--x’.

Here is an example of use the shell command “chacl”. Based on Table 4, type in “chacl dir1 jsmart=-rwx, guest=”, and then do a “ls-l dir1”. The results are displayed in Table 5. The “chacl” command removes the permissions for guest role and adds read/write/execute rights to j smart role. The changes made on ACL of dir1 affect ACL(s) of file(s) that are inherited from dir1. Files that have their own explicit ACLs stored in their inode are not affected. This explains that, in Table 5, the ACL of f3 is changed accordingly to reflect the changes made on ACL of dir1, and ACLs of f2 and f3 remain the same.

TABLE 5
Jsmart% chac1 dir1 jsmart=-rwx, guest=
Jsmart% 1s - 1 dir1

| dir1 | d | 9/21/2005 | 4:01pm | 256 | jsmart | -rwx |
|---|---|---|---|---|---|---|
| f1 | — | 9/25/2005 | 10:22am | 29 | jsmart | srwx |
| | | | | | guest | -r-x |
| f2 | — | 9/25/2005 | 10:23am | 58 | guest | -r-x |
| f3 | — | 9/25/2005 | 5:10pm | 16 | jsmart | -rwx |

Access Control Check 407

The access control check module 407 uses both the hierarchy of roles 411 and the ACLs 409 of resources 411. At the access control check module 407 the hierarchy of roles 411 and the ACLS 409 meet to provide the overall security of resources 411. The access check module 407 compares the EntityRole, i.e., the role of the entity E requesting access to a resource, against the roles defined by the ACL 409 having access rights on that resource on the other hand. Roles that are allowed to access the resource is given in the ACL of this resource. Not only roles included in the ACL have the right to access this resource, but also roles that are higher than any of these included roles should be able to access this resource as well.

The hierarchy of roles serves as the background knowledge to provide the information whether the requesting role is higher than roles included in ACL, if it is not one of them. That one role is higher than the other is equivalent to the existence of a path connecting two roles in the hierarchy. The “high than” relation is transitive. Thus, the length of the path is not limited to any fixed value. An extreme case of the path length is 1, where one role is a child of another.

The access check module 407 takes three arguments: filename, role ID and a flag that indicates how the file will be used. The function determines whether the access to this file by this role for this purpose should be granted or denied. The decision is made based on whether the ACL of this file contains a role that is the given role or one of its descendants. If the answer is yes, then the requested operation will be further compared against the permitted operations to determine whether to grant or deny the access. Otherwise, the access will be denied.

The check function is called to control the access when a file is to be opened. One parameter of the open file function is a flag to specify the purpose of opening the file. For example, the flag can be “to read”, “to write” or “to append”, etc. This flag is passed onto the access check function as one of its input. Once the access is granted for opening the file, the subsequent reads and writes do not require access checks. Setting the access check point at the moment to open a file is efficient and sufficient for the particular implementation on the file system of the Network Smart Card. It is efficient because it avoids repeated checks on reads and writes once a file has already been opened. Since any operation on a file must go through the step to open the file in the first place, it is also sufficient to call the access check only on the operation of opening file.

For other systems where there are multiple entry points towards the system resources, an access check may be performed on each possible “route” of interaction with the resource. To guarantee the security, access check points should cover all possible ways of accessing resources. However, properly choosing check points can improve the performance. Calling access check where several “routes” meet (e.g., the open file operation) is more efficient than calling access check at every possible “route”.

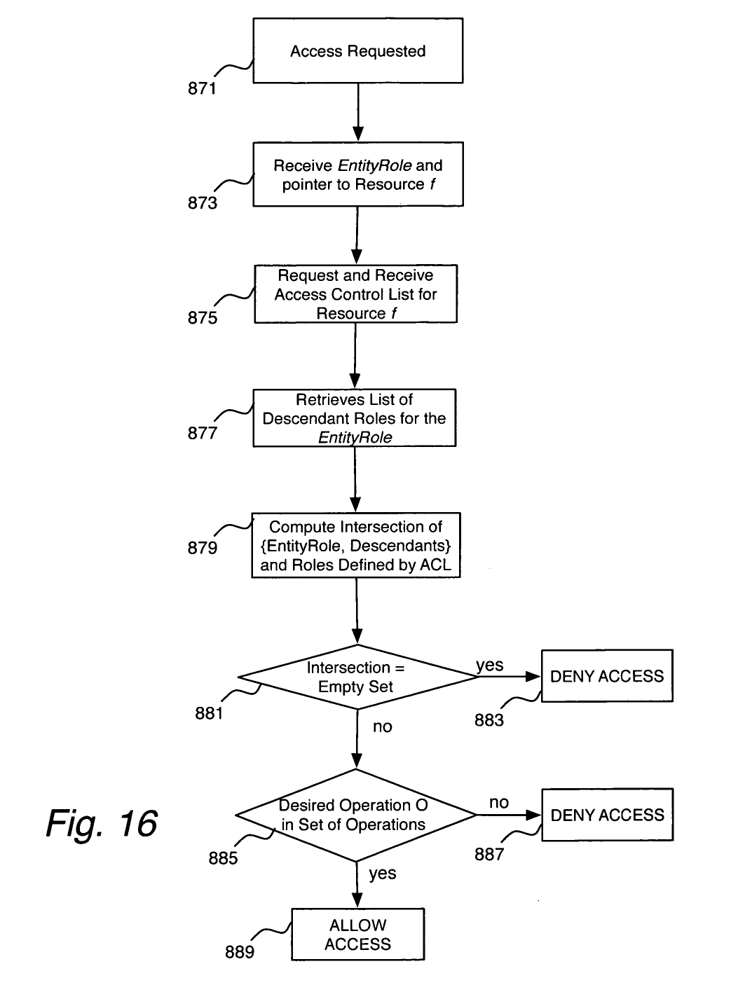

FIG. 16 is a flow-chart illustrating one embodiment of the operation of the access control check module 407. When an access is requested to perform an Operation O on a resource f step 871, the access control check module 407 receives the EntityRole of the requesting entity E, and a pointer to the resource f step 873. The access control check module 407 then requests and receives the access control list 409 for the resource f step 875. As discussed herein above, the retrieval of the access control list 409 for the resources f may rely on the inheritance of access control list from a file or directory higher in the file structure.

The access control check module 407 also retrieves the list of descendant roles 425 corresponding to the EntityRole, step 877.

Having obtained the list of roles and permissions from the access control list 409 and the list of descendant roles 425, the access control check module 407 computes the intersection between the set that includes the EntityRole and its descendants and the set of roles defined by the ACL 409, step 879.

If the intersection is the empty set, step 881, access is denied, step 883.

If the intersection is not the empty set, step 881, but the desired operation is not in the set of operations defined by the intersection, step 885, access is denied, step 887. Otherwise, the desired access is permitted, step 889.

An Optimization: A Calculator of Descendants

In theory, the comparison between two roles to find out whether one has a higher rank than another with respect to a hierarchy is symmetric. In reality, the requesting role is likely to be the same crossing over several comparisons, i.e., nearly static. On the contrary, ACLs and hence roles included therein are dynamic, as the resource for which access is requested changes. For instance, it is very likely for an entity E logged into a specific role to access several files, but the same file is less likely to be accessed by sequentially logged in entities. A global search on the hierarchy tree to find whether a “higher than” relation holds between two roles is costly. As one element of the comparing pairs may be the same, the global search is not necessary for each comparison. An optimized implementation is to have a module that calculates all descendants of any given role from the hierarchy, i.e., the calculator of descendants 405.

The calculator of descendants 405 of FIG. 4 provides this optimization step. Once an entity is logged into a role, the calculator of descendants queries the role hierarchy 401 and obtains all descendants of the logged-in role and may be stored as a List of Descendant Roles 425. All future comparisons for the determination of “high than” relationship are done between descendant roles and roles included in an ACL of a resource. This is taking the perspective of the logged-in role for the purpose of comparing a requesting role and a permitted role.

The list of descendant roles 425 is refreshed every time when a role is logged into. The hierarchy 401 is consulted only once, namely, when the calculator of descendants 405 for a logged in role is called, step 423 in FIG. 4. Thus, the performance is much improved. If the comparison were done from the perspective of a file to be accessed, the role hierarchy 401 would be queried every time when an access check is called and the requesting role is not included in the ACL of the file, to find out whether the requesting role is higher than the roles that are in the ACL. This latter approach is very costly in terms of CPU time.

Use Cases

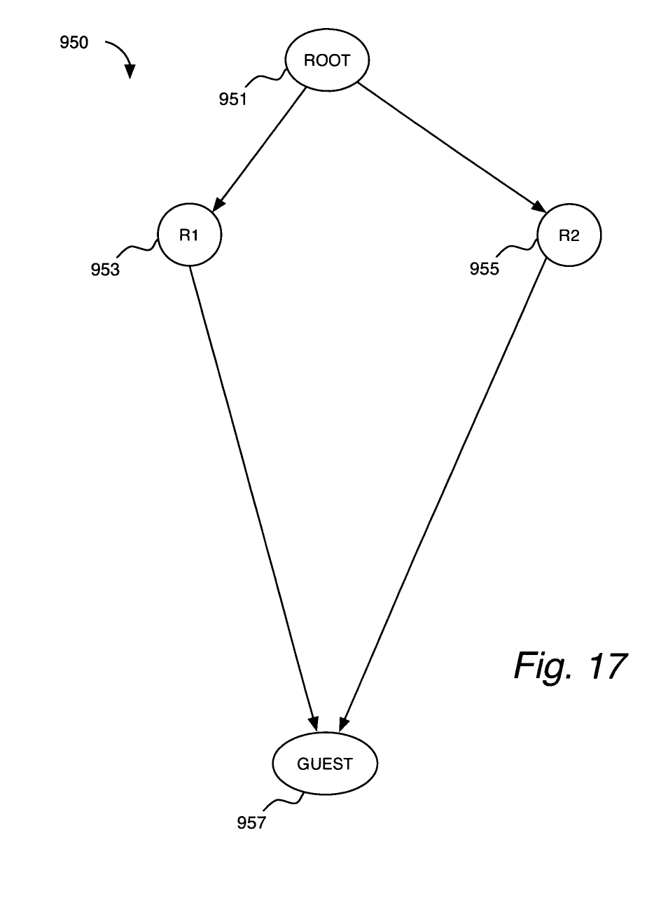

A series of stepwise examples below illustrate how the hierarchical role based access control mechanism according to the invention may operate on an electronic device, e.g., a Network Smart Card. The demonstration consists of two phases. The first phase is to show how the role hierarchy changes when a new role is created, a hierarchy link between two roles is removed or added. The second phase illustrates the manner in which the access of files is controlled via the role hierarchy. A part of an initial directory structure of the file system on the Network Smart Card is given in Table 6. FIG. 17 is a schematic illustration of an initial role hierarchy consisting of a ROOT role 951, a GUEST role 957 and two roles R1 953 and R2 955 between ROOT 951 and GUEST 957.

TABLE 6

/ <GUEST, srwx>

ws/ <GUEST, srwx>

index1.html <GUEST, srwx>
index2.html <GUEST, srwx>

home/ <GUEST, srwx>

ROOT/ <ROOT, srwx>
GUEST/ <GUEST, srwx>
R1/ <R1, srwx>
R2/ <R2, srwx>
R3/ <R3, srwx>

In Table 6, the syntax < . . . > indicates the ACL for the corresponding file or directory displayed to the left of the < . . . >. For example, the ACL for index1.html is <GUEST, srwx>.

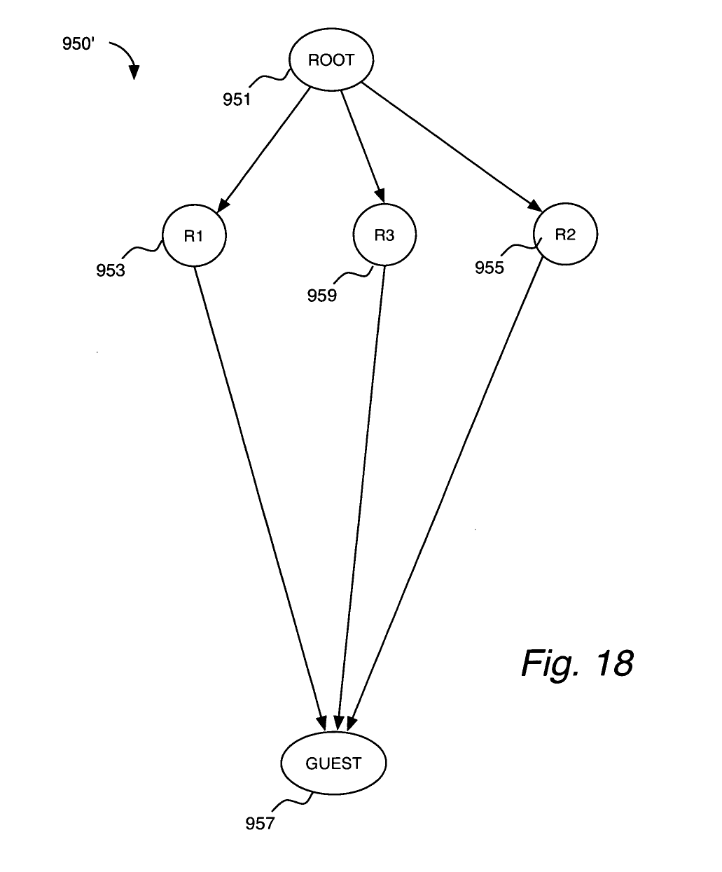

Step 1: Create a new role R3 959 between the ROOT 951 and the GUEST 957. Table 7 and hierarchy 950′ of FIG. 18 illustrate these changes.

TABLE 7

/ <GUEST, srwx>

ws/ <GUEST, srwx>

index1.html <GUEST, srwx>
index2.html <GUEST, srwx>

home/ <GUEST, srwx>

ROOT/ <ROOT, srwx>
GUEST/ <GUEST, srwx>
R1/ <R1, srwx>
R2/ <R2, srwx>
R3/ <R3, srwx>

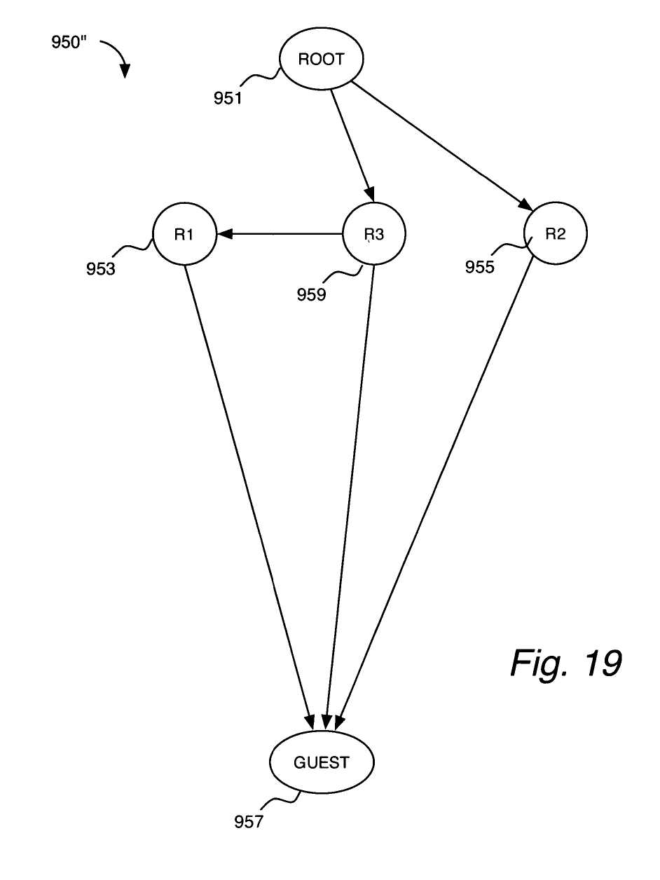

Step 2: Remove the hierarchical link from ROOT to R1, and add a link from R3 to R1. The hierarchy 950″ of FIG. 19 illustrates this change.

Step 3: Login as role R3. Create new files f1 and f2 under /home/R3/. Add <R2, -r--> in the ACL of f2. Table 8 illustrates the resulting file structure:

TABLE 8

/ <GUEST, srwx>

ws/ <GUEST, srwx>

index1.html <GUEST, srwx>
index2.html <GUEST, srwx>

home/ <GUEST, srwx>

ROOT/ <ROOT, srwx>
GUEST/ <GUEST, srwx>
R1/ <R1, srwx>
R2/ <R2, srwx>

R3/ <R3, srwx>

f1 <R3, srwx>
f2 <R3, srwx> <R2, -r-->

Step 4: Logout R3. Then do one of the following:
Login ROOT. ROOT can read both f1 and f2.
Login R2. R2 can read f2, but not f1.
Login R1. R1 can read none of f1 and f2.

This simple example demonstrates the powerful and flexible access control system available through deployment of the present invention.

An access control system according to the present invention provides for a powerful and flexible method that provides greater granularity and other hitherto unavailable efficiencies in the area of access control. By deploying a role based system the present invention provides a methodology for treating entities that previously were treated as distinct categories in a uniform fashion, the role. Roles for users and roles for applications can be created and placed properly in a hierarchy so that the access rights for users are separated from those of applications, thus, providing the flexibility of controlling the access on the application level. The hierarchy opens the possibility to require different login methods for different roles. The requirement of having dual logins to access some resources can be met with ease. Importantly, it also saves trouble from assigning commons rights to multiple roles and results in much shorter ACLs and hence uses far less memory space.

ACLs according to the invention also provide increased level of flexibility. First of all, the length of ACL is not fixed. An ACL can contain as many pairs of roles and permissions as needed. Second, the type of permissions and the number of permissions for a role in an ACL are easily expandable. New permissions can be added for new operations or subdividing existing ones. These flexibilities enable the functional level access control.

The access check module 407 brings together the infrastructure of the hierarchy of roles and ACLs attached to system resources. The access check module takes the perspective of the logged-in role, in the sense that all roles that are descendants of that logged-in role is determined once, because taking the perspective of a resource would require determining the descendants of a logged-in role on each resource access. The former is more efficient as can be understood from taking into consideration that a logged-in role needs to access multiple files is much more likely than that a file is to be accessed by a sequence of roles. Moreover, triggering the access check at the point where several routes of interacting with system resource meet (e.g., open file function for Unix like file system) provides the same security with a reduced CPU cost.

In one embodiment of the invention, the notion of inheriting ACLs along the hierarchical directory structure results in a big save on the memory usage.

The access control mechanism of the present invention may be advantageously deployed on a resource constrained device, e.g., on Network Smart Card, where saving on memory usage and CPU time is more limited, the present invention may be apply to any systems that require secure access to resources. By deploying the framework of hierarchical role based access control according to the invention, the security policies of any system is readily adjustable and extendible via the APIs of role hierarchy and ACLs.

From the foregoing it will be apparent that resource access control system and method of the present invention provides numerous advantages. An access control system according to the present invention provides a role based hierarchical structure in which relationships in access control can be established that parallel the relationships found in the “real” world. Furthermore, the access control method provides flexibility, high-level granularity, and efficiency.

Although specific embodiments of the invention have been described and illustrated, the invention is not to be limited to the specific forms or arrangements of parts so described and illustrated. The invention is limited only by the claims.

We claim:

1. A computer system having a data storage capacity and a central processing unit, the computer system comprising:
at least one resource;
an access control data structure defining role-based access control lists for the at least one resource, wherein the access control list defines based on the role of a user the types of access that the user may have to the at least one resource; and
a hierarchy of roles having at least a first role and a second role wherein the second role inherits the permissions granted to the first role for the at least one resource.

2. The computer system of claim 1, wherein:
at least one role in the hierarchy of roles is selected from the set consisting of a user, a program, a group of users, a group of programs.

3. The computer system of claim 1, comprising:
a login mechanism by which a user can indicate at least one role according to which a user wishes to log in.

4. The computer system of claim 1, comprising:
a login mechanism by which a user can indicate at least one role according to which a user wishes to log in and wherein the login mechanism provides login security policies are a function of the at least one role to which the user wishes to log in and which define a validation method that the user must satisfy in order to be logged in to the at least one role.

5. The computer system of claim 4, wherein a lower level role requires a simple login policy and a higher level role requires a rigorous login policy.

6. The computer system of claim 5 wherein the simple login policy selected from the set including no authentication, simple pin, simple password; and the rigorous login policy is selected from presenting a smart card, presenting a biometric information, presenting a digital certificate.

7. The computer system of claim 3, comprising:
a login mechanism by which a user may select the roles to which the user wishes to login and in response to a login request to a specified at least one role determining the login policy required for such a login request.

8. The computer system of claim 1, comprising:
a role-to-permission association for each resource item.

9. The computer system of claim 8 wherein the role-to-permission association for at least one resource item comprises a plurality of role-to-permission associations.

10. The computer system of claim 1 wherein the resource item is selected from the set including a file, a database record, a database table, a hardware device, an application, a virtual port, a socket, a cryptoprocessor, and a timer.

11. The computer system of claim 8 further comprising:
an optimizer operable to compute the descendant roles to a role to which a user has been validated.

12. The computer system of claim 10 further comprising:
an access control checker operable, in response to a validated user seeking access to a resource, to check whether one of the descendant roles has access privileges for the resource.

13. The computer system of claim 10 wherein a descendant role may descend from multiple ancestor roles.

14. The computer system of claim 8 wherein the permission for a role in the role-to-permission association for a particular item includes any operation permissible on the item.

15. The computer system of claim 12 includes operations selected from the set including set access control list, read, write, execute.

16. The computer system of claim 12 includes operations selected from the set including write_increase, write_decrease, increment, decrement.

17. The computer system of claim 12 includes operations selected from a set of operations applicable to the item.

18. The computer system of claim 1 wherein the at least one resource comprises at least two resources wherein a first resource is a descendant of a second resource; and
wherein the access control structure defines an access control list that specifies role-to-permission associations for the second resource; and
wherein the computer system further comprises:
logic for applying the role-to-permission associations of the second resource for any access to the first resource.

19. The computer system of claim 1 wherein the hierarchy of roles further comprising a third role and wherein the second role inherits from both the first role and the third role.

20. The computer system of claim 1 wherein in the hierarchy of roles, each role x inherits the permissions of all roles y in the hierarchy of roles if a role y is a descendant of role x.

21. A method of operating a computer system having a data storage capacity and a central processing unit, the computer system having at least one resource, the method comprising:
allowing an entity to login to a role wherein the role is a role defined in a hierarchy of roles having at least a first role and a second role wherein the second role inherits the permissions granted to the first role for the at least one resource;
in response to a request by an entity to access a resource, checking access privileges by determining whether the role to which the entity is logged in corresponds to a role for which access to the resource may be granted.

22. The method of operating a computer system of claim 21, wherein the step of checking access privileges comprises:
determining a set of descendant roles for the role to which the entity is logged in;
determining the roles that have access rights to the resource;
determining the intersection between the set including the role to which the entity is logged in and the set of descendant roles and the set of roles that have access rights to the resource.

23. The method of operating a computer system of claim 22, further comprising:
calculating the set of descendant roles in response to an entity logging in to a role.

24. The method of operating a computer system of claim 21, further comprising:
updating the hierarchy of roles in response to a command selected from the set having the members to add a new role, to delete a role, to change the hierarchical relationship between two roles.

25. The method of operating a computer system of claim 21, wherein the access control data structure defining role-based access control lists for the at least one resource, wherein the access control list defines based on the role of a user the types of access that the user may have to the at least one resource; and the hierarchy of roles having at least a first role and a second role wherein the second role inherits the permissions granted to the first role for the at least one resource.
